(19) United States
(12) Patent Application Publication
(10) Pub. No.: US 2005/0172308 A1
(43) Pub. Date: Aug. 4, 2005

(54) Disk holder and display device

(76) Inventor: John W. Roberts, Oak Park, IL (US)

Correspondence Address: Anthony Dowell;Dowell Baker, P.C., 1001 Main Street, Lafayette, IN, 47901, US

(21) Appl. No.: 11/050,939

(22) Filed: Feb. 4, 2005

Related U.S. Application Data
(63) Continuation-in-part of application No. 10/934,749, filed on Sep. 3, 2004.
(60) Provisional application No. 60/541,741, filed on Feb. 4, 2004.

(51) Int. Cl. G11B 19/20

(52) U.S. Cl. 720/703

(57) ABSTRACT

The disk mounting device of the present invention provides for the effective handling and display of CD's and DVD's. The disk mounting device is inserted in the central hole of a disk so that, when the disk is placed on a desk or table, the sensitive optical portion of the disk is supported away from the surface, reducing the risk of scratching the disk and making the disk easier to handle. Interlocking disk mounting devices are also disclosed to create disk mounting devices of different thicknesses that allow disks to be overlapped when stored or displayed. With disk mounting devices of different thicknesses, disks may be overlapped to conserve space and/or to create an attractive visual display.

### CROSS-REFERENCE TO RELATED APPLICATION

This application claims priority under 35 U.S.C. § 119(e) to U.S. Provisional Application Ser. No. 60/541,741 entitled “Method and device of holding, storing and displaying CDs, DVDs and other disks” and filed Feb. 4, 2004.

### FIELD OF THE INVENTION

The present invention relates to the holding and displaying of compact disks, digital video disks and other disk storage and entertainment media.

### BACKGROUND OF THE INVENTION

Compact disks (“CD's”) have become the preferred media for distributing and playing music and computer software. CD's are also commonly used in the home and office to store and distribute data and computer files. DVD's are the preferred media for distributing and playing movies in the home, and are now also commonly used to distribute computer software and store and distribute large computer files. The ubiquity and multitude of CD's and DVD's in the home and office has led to the need for storage devices for these disks.

Because of the sensitive nature of CD's and DVD's, storage devices for these disks must protect the disks from breaking and cracking as well as protect the sensitive surface of the disk from scratching, dirt and fingerprints. Even minute dirt particles can cause scratches when rubbed between the disk and another surface. However, many users of CD's and DVD's do not routinely return the disks to their protective cases, and instead simply lay the disk on the nearest available desk or countertop surface. This carelessness with the disks can lead to scratching of the bottom surface of the disk and cause the disk to become unusable. Also, when placed on a flat surface, CD's and DVD's are difficult to pick up, and must often be slipped off of the surface to grasp the disk. This treatment of the disks also tends to scratch and cause problems with CD's and DVD's.

To avoid these problems, users of CD's and DVD's have sought storage devices and systems that protect the sensitive disks. Users also seek storage systems that allow large numbers of disks to be stored in a single location. Previous methods and devices for storing and handling CD's have met these objectives with varying degrees of success.

Many users of CD's and DVD's also seek to display the CD's or DVD's themselves because the disks often come with photographs or graphic designs on their surface. Users may also seek to display CD's or DVD's so that they may be quickly identified, located and used, resulting in savings in time at the workplace and at home. Most prior art disk storage devices and systems do not allow for the disk to be displayed for aesthetic purposes or for ease of reference. Instead, many prior art devices store disks in sleeves or compartments that make locating the disks a challenge. Also, the disks may be scratched or damaged when inserted or removed from the sleeves and compartments of many prior art storage devices.

The standard method of commercially distributing CD's is the jewel case. Other types of encapsulated disk storage devices may be found in U.S. Pat. No. 5,931,291 issued to Sedon, U.S. Pat. No. 5,593,030 issued to Tell, U.S. Pat. No. 4,908,817 issued to Sandell and U.S. Pat. No. 4,871,065 issued to Iiehn. Although all of these devices provide protection for the disk, they do not allow for mass storage of disks or allow for display of the disks.

Prior art devices that have provided for mass storage of disks include U.S. Pat. No. 5,505,299 issued to Ditzig, U.S. Pat. No. 5,344,028 issued to Angele and U.S. Pat. No. 350,448 issued to Hill. Although these prior devices allow for the storage of many disks, they also do not allow for the display of the disks and require a user to search through the devices to locate a specific disk.

U.S. Pat. No. 5,609,258 issued to Spector discloses a device for displaying disks in a wall mounted display. This device provides for quick visual identification of the disks and avoids the problem of having to search through a storage container to locate the disks. This device, however, does not allow for the overlapping of disks, which increases the number of disks that may be stored in a given space. Also, this device does not protect the sensitive underside of the disks from contacting a surface, which can lead to scratching of the disks.

Accordingly, it is an object of the present invention to provide a device and system that stores multiple CD's and DVD's.

A further object of the present invention is to provide a device and system that makes handling CD's and DVD's easier and also prevents the sensitive underside of the CD's and DVD's from contacting a surface when the disk is placed on a desk or table.

Another object of the present invention is to provide a device and system for storing and displaying CD's and DVD's so that any graphics or identification on the disk may be viewed with ease.

Finally, an object of the present invention is to provide a device and system for storing CD's and DVD's that is economical to manufacture, easy to use, simple in design and refined in appearance.

### SUMMARY OF THE INVENTION

The preferred embodiment of the present invention provides a disk mounting device that may be inserted in the central hole of a CD or DVD from the underside of the disk. When inserted, the annular shoulder of the device contacts the non-sensitive portion of the underside of the disk. When placed on a desk or table with the device inserted, the sensitive optical portion of the disk is supported and does not contact the desk or table, reducing the risk of scratching the disk. Also, with the device inserted, the disk is easier to handle and pick up from a horizontal surface. Multiple disk mounting devices may be used to simplify the handling of disks and ensure that disks do not become damaged when handled or temporarily stored on a desktop.

The device may also be provided with a recess so that the disk mounting devices may be interlocked. With two or more of the devices interlocked, a disk holding device of increased thickness is created by the combined devices. With disk mounting devices of different thicknesses, disks may be overlapped to conserve space and/or create an attractive visual display. The interlocking devices also allow disks to be overlapped when stored or displayed. These and other advantages will become apparent as this specification is read in conjunction with the accompanying drawings and appended claims.

### BRIEF DESCRIPTION OF THE DRAWINGS

FIG. 1 is a perspective view of the disk mounting device of the present invention.

FIG. 2 is a side view of the disk mounting device of the present invention.

FIG. 3 is a perspective view of the bottom side of the disk mounting device of the present invention.

FIG. 4 is a side view the disk mounting device of the present invention inserted into a disk.

FIG. 5 is a perspective view of two disk mounting devices of the present invention interlocked with each other.

FIG. 6 is a side view of the interlocking disk mounting devices of the present invention showing how multiple disks may be displayed and overlapped.

FIG. 7 is a top view of two disks stored in an overlapping position with the disk mounting devices of the present invention.

### DETAILED DESCRIPTION

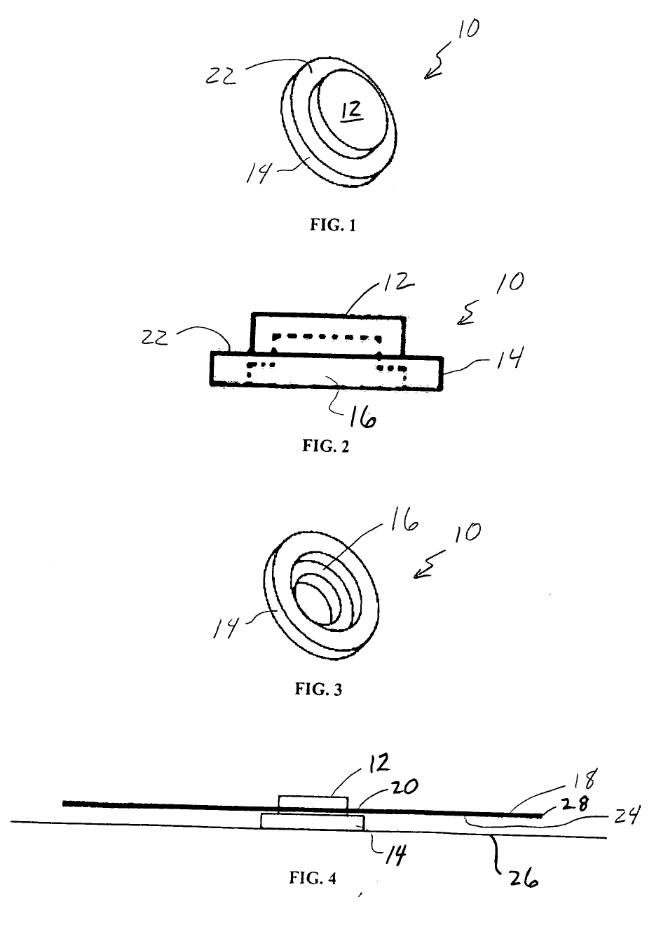

FIGS. 1-3 show a disk mounting device 10 of the present invention. The disk mounting device 10 is comprised of a central hub 12 and a concentric circular base 14. The diameter of the central hub 12 is preferably sized to match the central hole of a CD and/or DVD disk 18, although disk mounting devices for use with other sizes and types of disks are also contemplated and within the scope of the present invention. The central hub 12 is sized to match the central hole of a disk 18 so that the disk mounting device 10 may be inserted into the disk, as shown in FIG. 4. The diameter of the of the circular base 14 is preferably sized to match the non-sensitive annular portion 20 of the disk 18 immediately adjacent the hole, although other sizes may also be used.

Although a rigid material may be used, the disk mounting device 10 is preferably made of a flexible material such as rubber or flexible plastic so that the central hub 12 may be easily inserted and removed from the hole of a disk 18. When inserted, the non-sensitive annular portion 20 of the disk 18 (shown in FIG. 7) rests on the annular shoulder 22 of the disk mounting device 10. In this position, the disk 18 may be easily handled by grasping the disk mounting device 10.

As shown in FIG. 4, the disk 18 may be set on a horizontal surface 26 with the disk mounting device 10 inserted. The sensitive annular portion 24 of the disk 18 is safely suspended above the horizontal surface 26 and thus cannot be scratched by contact with the surface. Even if the disk is jostled or tipped so that the edge 28 of the disk 18 contacts the surface 26, the sensitive annular portion 24 remains out of contact with the surface.

Multiple disk mounting devices 10 are preferably provided at every home or work station where CD's and/or DVD's are routinely used and handled. When a disk is removed from a computer, CD player or DVD player, the disk mounting device may be immediately inserted. With the disk mounting device 10 inserted, the disk may be more easily and safely handled by grasping the device. If the disk needs to be set down for a moment or longer, the user can do so with the knowledge that the disk will not be scratched and that he or she will be able to easily pick up the disk when it is again needed.

As shown in FIG. 3, the disk mounting device 10 also includes a recess 32 on the bottom side of the device. As shown in FIG. 2, the recess 16 is sized to receive the central hub 12 of a similarly sized disk mounting device. As shown in FIG. 5, the recess 16 allows a disk mounting device 10 to be interlocked with a similar sized disk mounting device 11.

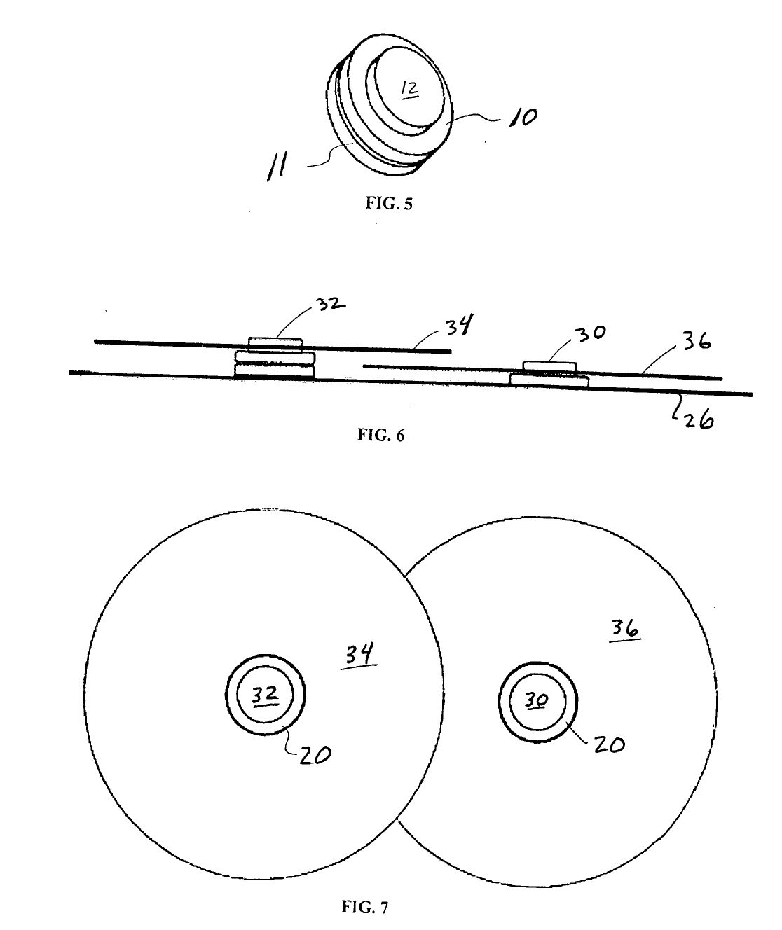

Several storage and display advantages may be realized with the use of the interlocking disk mounting devices 10 and 11. As shown in FIG. 6, a single disk mounting device 30 may be used in combination with multiple interlocked disk mounting devices 32 to allow disks 34 and 36 to be stored in an overlapping position. Because the interlocked disk mounting devices 32 are taller than a single disk mounting device 30, the disk 34 is suspended at a greater distance from the surface 26 than disk 34. Alternatively, disk mounting devices of different heights could also be used to achieve the same result. The different heights of the disk mounting device 30 and the interlocked disk mounting devices 32 allow the disks 34 and 36 may to be stored or displayed so that they overlap, as shown in FIG. 7.

The disks 34 and 36 may be temporarily stored in an overlapping position on a desk to conserve valuable desk space. Alternatively, disks may be stored and displayed on a vertical surface with the disks overlapping. Although overlapping, the disks may nonetheless be easily, quickly and accurately identified when stored in this position, speeding their retrieval and use.

In addition to conserving space, attractive visual displays may be created by overlapping disks on a vertical surface. A common graphic design among multiple disks may be used that can be viewed when the disks are stored. Thus, for example, the multiple DVD's of a movie or series of movies can be stored in an attractive wall display with the graphics on the disks integrated with the graphics of the surrounding display. A vertical display of disks may also speed the location, retrieval and return of disks to the storage space.

The disk mounting devices of the present invention may be attached to a wall or vertical surface through any number of means. The devices may be permanently affixed to a display or temporarily and removably attached by adhesives or other means such as Velcro.

Other alterations, variations and combinations are possible that fall within the scope of the present invention. Although preferred embodiments of the present invention have been described, those skilled in the art will recognize other modifications that may be made that would nonetheless fall within the scope of the present invention. Therefore, the present invention should not be limited to the apparatus described. Instead, the scope of the present invention should be consistent with the invention claimed below.

1. A disk mounting device for use with an optical disk having a central hole and an annular optically sensitive portion with an inside diameter and an outside diameter on at least one side of the disk, the disk mounting device comprising:
a circular base having a bottom, a top, and a side with a diameter less than or equal to the inside diameter of the optically sensitive portion of the optical disk;
a circular hub having a bottom connected to the top of the circular base, a top and a side concentric with the side of the circular base, the side of the circular hub having a diameter sized for insertion into the central hole of the optical disk.

2. The disk mounting device of claim 1 further comprising:
a circular recess in the bottom of the circular base, the circular recess having a diameter sized for reception of a circular hub of a similarly sized disk mounting device.

3. A set of disk mounting devices for mounting and displaying optical disks having a central hole and an annular optically sensitive portion with an inside diameter and an outside diameter on at least one side of the disk, the set of disk mounting devices comprising:
a first disk mounting device;
a second disk mounting device;
the first and second disk mounting devices each having a circular base with a bottom, a top, and a side with a diameter less than or equal to the inside diameter of the optically sensitive portion of the optical disk;
the first and second disk mounting devices also each having a circular hub having a bottom connected to the top of the circular base, a top, and a side concentric with the side of the circular base, the side of the circular hub having a diameter sized for insertion into the central hole of the optical disk;
the side of the circular base of the first disk mounting device having a first thickness;
the side of the circular base of the second disk mounting device having a second thickness greater than the first thickness.
